(19) United States
(12) Patent Application Publication
(10) Pub. No.: US 2013/0127992 A1
(43) Pub. Date: May 23, 2013

(54) METHOD OF CONVERTING VIDEO IMAGES TO THREE-DIMENSIONAL VIDEO STREAM

(71) Applicant: PLANNET ASSOCIATE CO., LTD., Yokohama City (JP)

(72) Inventor: Mamoru SAITOH, Yokohama City (JP)

(73) Assignee: PLANNET ASSOCIATE CO., LTD., Yokohama City (JP)

(21) Appl. No.: 13/742,070

(22) Filed: Jan. 15, 2013

Related U.S. Application Data
(63) Continuation of application No. PCT/JP2011/066552, filed on Jul. 21, 2011.

(30) Foreign Application Priority Data
Jul. 21, 2010 (JP) JP 2010-163583
Sep. 7, 2010 (JP) JP 2010-199837

(51) Int. Cl. H04N 13/00

(52) U.S. Cl. CPC H04N 13/0048
USPC 348/43

(57) ABSTRACT

A method is provided which comprises a first processing step that demultiplexes each of a left-eye video image file and a right-eye video image file which were recorded with time synchronization and in accordance with MPEG4-AVC standard, and a second processing step that multiplexes the demultiplexed data of the left-eye video image file and the right-eye video image file into one elementary stream data at least without encoding and in accordance with MPEG4-MVC standard, wherein the demultiplexing is performed so that image data and audio data from one of the left-eye video image file and the right-eye video image file, demultiplexed in the first processing step, are used as base views of the elementary stream data and image data from the other is used as dependent views of the elementary stream data.

### BACKGROUND OF THE INVENTION

1. Technical Field of the Invention

The present invention relates to a method of converting two-dimensional video streams to a three-dimensional video stream and also relates to a program for the method.

2. Description of the Related Art

As a method of converting two-dimensional video streams to a three-dimensional video stream, a method disclosed in Patent Literature 1 (Japanese Published Patent Application No. 2006-191357) is known. In this method, one of a left-eye video image and a right-eye video image both captured by a camera for imaging a pair of right and left images is compressed while a physical amount is extracted which represents a difference in vision (disparity or parallax) between respective frame images (left-eye image and right-eye image) captured by the camera (the physical amount may be a disparity vector which represents a disparity direction and a disparity amount), and the magnitude of the extracted disparity vector is used to calculate depth information regarding depths of the left-eye image and the right-eye image which are required for producing three-dimensional video images. Thereafter, this depth information is stored in a user data region of an MPEG video stream subjected to an MPEG compression encoding process in accordance with the DVD video format.

### SUMMARY OF THE INVENTION

According to the above conversion method disclosed in Patent Literature 1, however, a decoding process is necessary when such compressed data is used because data prior to the compression of each frame image captured by the camera is required for the processes for extracting the disparity vector between the left-eye video image and the right-eye video image and calculating the depth information. Therefore, problems occurs that the calculating process requires a long period of time and the calculation program becomes complex.

Problems to be solved by the present invention include reducing the load of a conversion process from two-dimensional video streams to a three-dimensional video stream.

The present invention solves the above problems by demultiplexing each of a left-eye video image file and a right-eye video image file which were recorded with time synchronization and in accordance with MPEG4-AVC standard, and thereafter multiplexing this demultiplexed data of the left-eye video image file and the right-eye video image file into one elementary stream data at least without encoding and in accordance with MPEG4-MVC standard so that the multiplexing is performed for unprocessed image data as a dependent view without processing extraction of a difference between image data of the dependent view and image data of a base view.

According to another aspect of the present invention, there is provided a computer-readable storage medium encoded with instructions that, when executed, cause one or more processors to perform a method as disclosed herein.

According to the present invention, two-dimensional video streams are converted to a three-dimensional video stream by multiplexing the demultiplexed left-eye video image and right-eye video image without encoding so that video image data of one of them is not to be processed through decoding followed by extraction of a difference followed by encoding, thus allowing the load of conversion process to be reduced.

### BRIEF DESCRIPTION OF DRAWINGS

FIG. 1 is a diagram for explaining a conversion method according to one embodiment of the present invention;

FIG. 2 is a structural diagram illustrating video planes of three-directional video images;

FIG. 3 is a diagram illustrating a disc configuration responsible for three-dimensional video images according to the Blu-ray standard;

FIG. 4 is a diagram illustrating a data structure of an elementary stream responsible for three-dimensional video images; and

FIG. 5 is a diagram illustrating a data structure of an SSIF responsible for three-dimensional video images.

### DESCRIPTION OF THE PREFERRED EMBODIMENT

Standards for Blu-ray three-dimensional images will now be overviewed. According to the Blu-ray standard established by Blu-ray Disc Association (BDA), Profile 5 is formulated responsible for recording/reproducing three-dimensional images. As the Profile definitions of the Blu-ray standard, Profile 1 is formulated responsible for BD-AV, BD-MV and BD-J, Profile 2 further for BD-LIVE, and Profile 5 still further for three-dimensional images.

MPEG4-MVC standard is used for three-dimensional video in accordance with the Blu-ray standard. MVC is abbreviation of Multi-view Video Coding. MPEG4-MVC is ranked as an extended standard of MPEG4-AVC (H.264) and formulated on the basis of MPEG4-AVC, thus ensured to be compatible with MPEG4-AVC.

Three-dimensional images in accordance with MPEG4-MVC standard have independent streams (referred to as views) for left-eye and right-eye, and comprise base views that constitute a main stream and dependent views that constitute a sub stream. Base views have compatibility with MPEG4-AVC, and a two-dimensional reproduction device uses only these base views to reproduce two-dimensional images. Dependent views also have compatibility with MPEG4-AVC, but consist only of differences from base views. Note that it can freely be specified as to which stream for left-eye or right-eye is used as base views or dependent views, or vice versa.

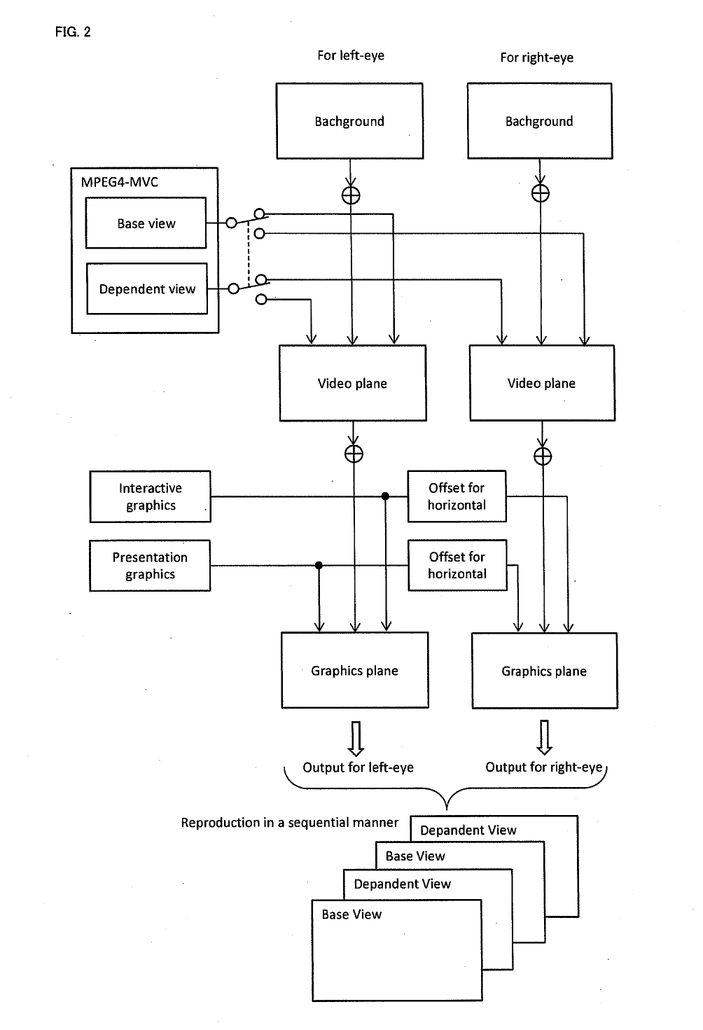

FIG. 2 is a structural diagram illustrating video planes of three-directional video images, wherein the above-described base views and dependent views are assigned to respective video planes of a left-eye stream and a right-eye stream, which are overwritten thereon with right-eye and left-eye planes for interactive graphics that represent images of menu, buttons and other items and for presentation graphics that represent subtitles, and ultimate three-dimensional video images can thus be obtained. Further, the base views and the dependent views for the three-dimensional video images are decoded and subjected to a reproduction process in a frame sequential manner, and the three-dimensional video images can thereby be presented for being viewed.

For use in reproducing three-dimensional video in accordance with the Blu-ray standard, there is a method which utilizes an elementary stream used for reproducing conventional two-dimensional video. An elementary stream is configured such that the above-described base views and dependent views are multiplexed into one m2ts file for which a playlist file and a clip information file exist corresponding thereto, and the reproduction control is performed using the clip information file that was specified by a play item.

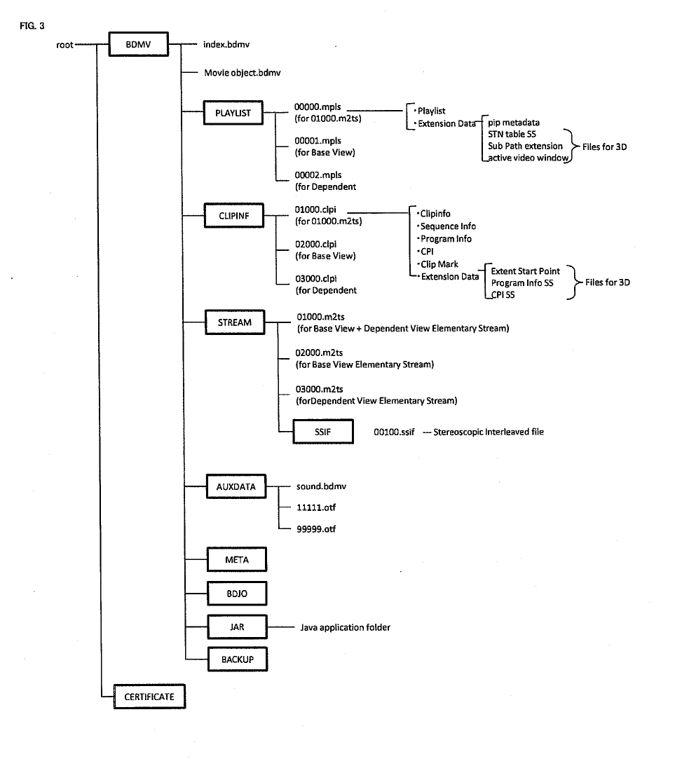

In an elementary stream responsible for three-dimensional video images, a control file for two-dimensional video images is added thereto with an extension file for three-dimensional video images in terms of each of the playlist file and the clip information file. FIG. 3 illustrates a disc configuration responsible for three-dimensional video images in accordance with the Blu-ray standard. As shown in the figure, an extension data file “Extension Data” for three-dimensional video images is added to a playlist folder “PLAYLIST” in addition to a playlist file “Playlist” for two-dimensional video images, and an extension data file “Extension Data” is added in a similar manner to a clip information folder “CLIPINF” in addition to a clip information file “Clipinfo” and other files for two-dimensional video images. Reproduction of three-dimensional video images refers to these extension data files of the playlist folder and the clip information folder.

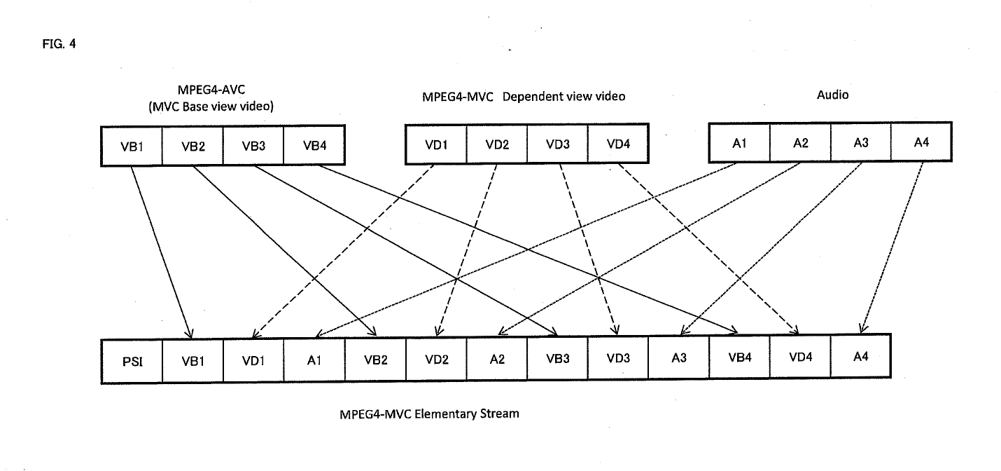

FIG. 4 is a diagram illustrating a data structure of an elementary stream responsible for three-dimensional video images, wherein the elementary stream is configured such that base views VB1 to VB4, dependent views VD1 to VD4 and audio data A1 to A4 are multiplexed into one stream along with interactive graphics that represent images of menu, buttons and other items and with presentation graphics that represent subtitles, as described above. Therefore, when reproducing the multiplexed elementary stream file, this file may be decoded.

Meanwhile, in the event of converting two-dimensional video images to three-dimensional video images for appreciation thereof, the conventional conversion method involves problems that processes for extracting disparity vectors and calculating depth information require a long period of time and that a program for calculation becomes complex.

For three-dimensional video images of Blu-ray standard, however, the conversion process can be performed in a short period of time with a simple program and without performing a process for compressing the video images and a process for calculating depth information if a left-eye video image file and a right-eye video image file (m2ts files) in accordance with MPEG4-AVC standard would be converted into one elementary stream in accordance with MPEG4-MVC standard and the playlist file and the clip information file as files for the reproduction control would be converted to those responsible for three-dimensional video images. In particular, according to the present example, the left-eye and right-eye video image files having been demultiplexed are re-multiplexed into the elementary stream of MPEG4-MVC at least without being encoded, thereby to reduce the calculation load. The description will then be directed to a conversion method and a conversion program according to one embodiment of the present invention applied thereto.

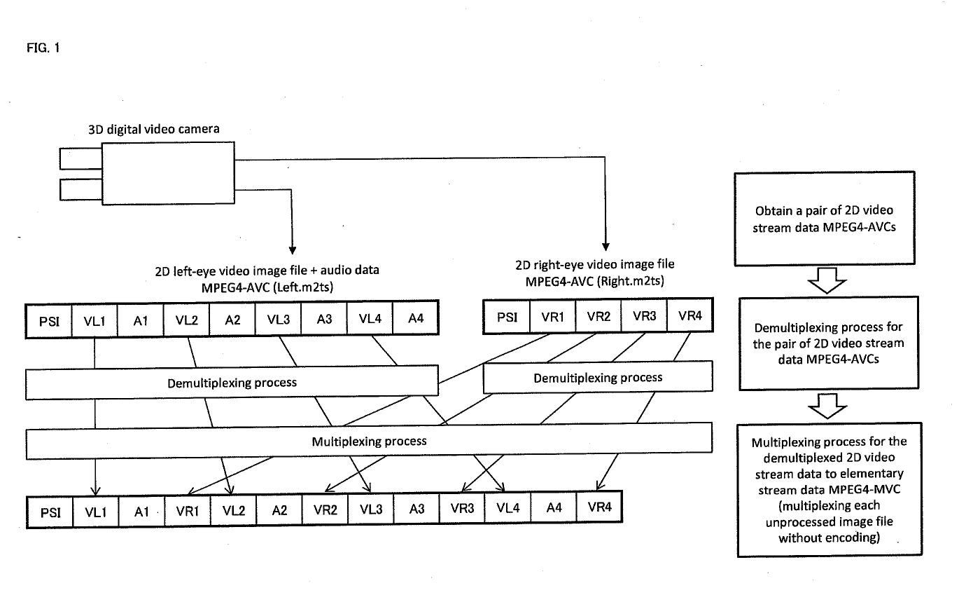

FIG. 1 is a diagram illustrating the conversion method and a data structure in the present example. Two-dimensional video images to be used in the present example are associated with a left-eye video image file and a right-eye video image file which were obtained to have a predetermined disparity, and can be obtained using a digital video camera for capturing three-dimensional video images, for example. These left-eye video image file and right-eye video image file are multiplexed into m2ts files in accordance with MPEG4-AVC of the Blu-ray standard and are recorded with time synchronization to each other in a BD medium or other appropriate medium. When converted to three-dimensional video images, these video image files may be converted after being read out from a BD medium or other medium such as an SD card or otherwise converted after being downloaded to a conversion device via an electric communication line such as the Internet.

It is assumed in the example of FIG. 1 that a Left.m2ts file multiplexed therein with the left-eye video image file and audio data and a Right.m2ts file multiplexed therein only with the right-eye video image file are recorded with time synchronization to each other. In the figure, VL1, VL2, VL3 and VL4 denote left-eye video image data, A1, A2, A3 and A4 denote audio data, and VR1, VR2, VR3 and VR4 denote right-eye video image data. In addition, each of the left-eye video image file and the right-eye video image file has PSI (Program Specific Information) which is table data stored with a list of packet IDs (PIDs) contained in each stream, etc.

According to the conversion processing method of the present example, the multiplexed left-eye video image file and right-eye video image file in accordance with MPEG4-AVC standard are each demultiplexed, and video image data and audio data of these demultiplexed left-eye video image file and right-eye video image file are re-multiplexed into one elementary stream data in accordance with MPEG4-MVC standard.

FIG. 1 illustrates in its lower part the one re-multiplexed elementary stream. According to the example of the figure, image data and audio data of the left-eye video image file are extracted as the base views of the elementary stream data from the demultiplexed data, image data of the right-eye video image file is extracted as the dependent views of the elementary stream data from the demultiplexed data, and the re-multiplexing is performed for the extracted data.

In this operation, unprocessed image data of the right-eye video image file is multiplexed as the dependent views of MPEG4-MVC without extraction processing for a difference between the image data of the dependent views and the image data of the base views. According to the present example, the image data of the right-eye video image file is multiplexed without being processed through decoding followed by extraction of a difference followed by encoding, and the calculation load can thus be reduced to shorten the period of time for conversion even though the stream capacity increases. In addition, the program for conversion can also be simplified.

Note that it can freely be set as to which of the left-eye video image file or the right-eye video image file is used as the base views, and the right-eye video images may be assigned to the base views and the left-eye video images to the dependent views.

At the time of re-multiplexing into an elementary stream in accordance with MPEG4-MVC standard, the stream format of a stream corresponding to the dependent views is changed from 0×1B in accordance with MPEG4-AVC standard to 0×20 in accordance with MPEG4-MVC standard, wherein the stream format is recorded in a program map table of program header information PSI of the created elementary stream (m2ts file).

In addition, playlist file information for the base views is registered to a movie playlist file for reproduction control of the elementary stream data, as shown in FIG. 3. Further, a movie playlist extension file “Extension Data” for reproduction control of three-dimensional video stream data is added to the movie playlist file for reproduction control of the elementary stream data as shown in the figure, and playlist file information of the dependent views is registered to an “STN table SS” file of that extension file.

In addition, clip information file information of the base views is registered to a clip information file for reproduction control of the elementary stream data, as shown in FIG. 3. Further, a clip information extension file “Extension Data” for reproduction control of three-dimensional video stream data is added to the clip information file for reproduction control of the elementary stream data, and clip information file information of the dependent views is registered to each of a “Program Info” file and a “CPI SS” file of that extension file.

According to the above conversion process, there are obtained one elementary stream data in which left-eye video image data, right-eye video image data and audio data are multiplexed and files for reproduction control which are responsible for the reproduction control of the three-dimension video images, and they are recorded on a BD-R or BD-RE medium with Blu-ray BDAV format. Further, decoding them using a reproduction device allows the three-dimensional video images to be presented for being viewed.

Note that any user interface such as menu may be added using interactive graphics and/or presentation graphics in accordance with Blu-ray HDMV format or BD-J format involving navigation functionality. In addition, any functionality such as BD-LIVE may be added. Note also that such disc images may be utilized as image information when creating BD-ROMs.

As described above, according to the conversion method and the conversion program of the present example, the conversion process into MPEG4-MVC format includes multiplexing unprocessed data without performing a difference extraction process for dependent views thereby to allow the conversion process to be performed in a short period of time and with a simple program, thus being applicable to a simplified three-dimensional video image producing device.

### Another Embodiment

For use in reproducing three-dimensional video in accordance with the Blu-ray standard, there is a method which utilizes an SSIF (Stereoscopic Interleaved File), other than the above method which utilizes an elementary stream. The SSIF is a file obtained by coupling a stream of the base views and a stream of the dependent views, which are independent from each other.

The SSIF uses the base views and the dependent views respectively as a main TS and a sub TS, both of which constitute one stream as an “ssif” file, which is located in an SSIF folder “SSIF” of the stream folder “STREAM” shown in FIG. 3, and the SSIF can thereby be reproduced as three-dimensional video images. Note that the SSIF folder “SSIF” may be located only when an “ssif” file exists, and is an essential functionality to a reproduction device for Profile 5 of the Blu-ray standard, but may be absent as a disc configuration if no “ssif” file exists.

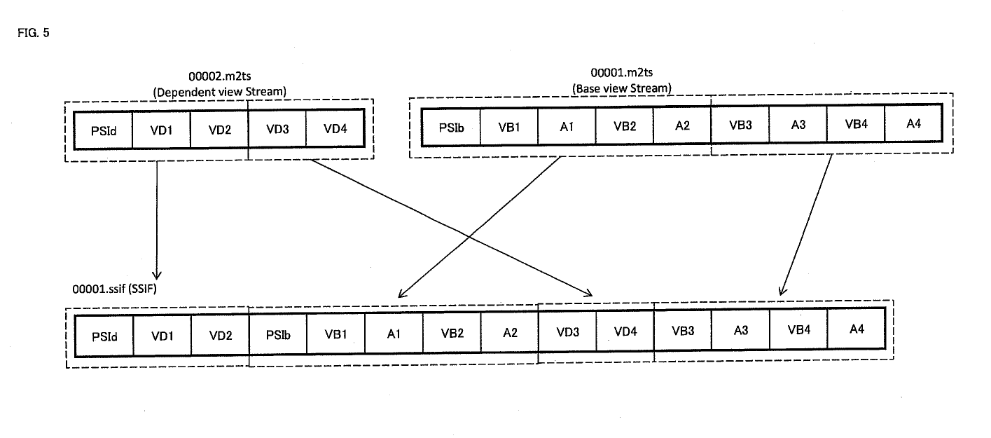

A stream of the SSIF has a stream configuration in which the base views and the dependent views are multiplexed to be independent from each other, and is produced such that respective streams are interleaved with each arbitrary size. This aspect is illustrated in FIG. 5. In the present example, distribution of the base view stream and the dependent view stream in the SSIF file is specified by an “Extent Start Point” file in the clip information file shown in FIG. 3. In addition, the dependent view stream is specified by a sub path “Sub Path Extension” in the playlist file of the playlist folder “PLAYLIST” shown in the figure, and the clip information file is made such that the base views and the dependent views are also independent from each other.

Meanwhile, the reproduction of three-dimensional video images using the SSIF folder “SSIF” and the “ssif” file is available only from a disc, and reproduction via downloading such as by BD-LIVE is not available. In this respect, according to the present example, when the reproduction is performed using BD-LIVE on the basis of the m2ts file of the base views and the m2ts file of the dependent views shown in FIG. 5, these multiplexed m2ts files of the base views and the dependent views are each demultiplexed, and the demultiplexed image data from the dependent views and the demultiplexed image data and audio data from the base views are re-multiplexed into one elementary stream.

Note that the procedure of demultiplexing these m2ts files of the base views and the dependent views and re-multiplexing into one elementary stream may be similar to that of the above-mentioned embodiment. Note also that the re-writing process for relevant movie playlist file and clip information file during the re-demultiplexing may also be performed in a similar manner to the above-described embodiment.

Further, the re-multiplexed elementary stream is downloaded to thereby allow for BD-LIVE where three-dimensional video images are reproduced.

What is claimed is:

1. A method of converting two-dimensional video stream data to three-dimensional video stream data, the method comprising:
a first processing step that demultiplexes each of a left-eye video image file and a right-eye video image file which were recorded with time synchronization and in accordance with MPEG4-AVC standard; and
a second processing step that multiplexes the demultiplexed data of the left-eye video image file and the right-eye video image file into one elementary stream data at least without encoding and in accordance with MPEG4-MVC standard, wherein
the second processing step comprises:
using image data and audio data from one of the left-eye video image file and the right-eye video image file, demultiplexed in the first processing step, as a base view of the elementary stream data;
using image data from the other as a dependent view of the elementary stream data; and
performing multiplexing of unprocessed image data as the dependent view without processing extraction of a difference between the image data of the dependent view and the image data of the base view.

2. The method of converting as set forth in claim 1, wherein
the second processing step includes:
a processing that changes a stream format of program header information in the multiplexed elementary stream data from a format in accordance with MPEG4-AVC standard to a format in accordance with MPEG4-MVC standard;
a processing that registers playlist file information of the base view to a movie playlist file for reproduction control of the elementary stream data;
a processing that adds a movie playlist extension file for reproduction control of three-dimensional video stream data to the movie playlist file for reproduction control of the elementary stream data and registers playlist file information of the dependent view to that extension file;
a processing that registers clip information file information of the base view to a clip information file for reproduction control of the elementary stream data; and
a processing that adds a clip information extension file for reproduction control of three-dimensional video stream data to the clip information file for reproduction control of the elementary stream data and registers clip information file information of the dependent view to that extension file.

3. The method of converting as set forth in claim 1, wherein
the first processing step includes a processing that downloads the left-eye video image file and the right-eye video image file via an electrical communication line.

4. A computer-readable storage medium encoded with instructions that, when executed, cause one or more processors to perform a method of converting two-dimensional video stream data to three-dimensional video stream data, the method comprising:
a first processing step that demultiplexer each of a left-eye video image file and a right-eye video image file which were recorded with time synchronization and in accordance with MPEG4-AVC standard; and
a second processing step that multiplexes the demultiplexed data of the left-eye video image file and the right-eye video image file into one elementary stream data at least without encoding and in accordance with MPEG4-MVC standard, wherein
the second processing step comprises:
using image data and audio data from one of the left-eye video image file and the right-eye video image file, demultiplexed in the first processing step, as a base view of the elementary stream data;
using image data from the other as a dependent view of the elementary stream data; and
performing multiplexing of unprocessed image data as the dependent view without processing extraction of a difference between the image data of the dependent view and the image data of the base view.

5. The computer-readable storage medium as set forth in claim 4, wherein
the second processing step includes:
a step that changes a stream type of program header information in the multiplexed elementary stream data from a type in accordance with MPEG4-AVC standard to a type in accordance with MPEG4-MVC standard;
a step that registers playlist file information of the base view to a movie playlist file for reproduction control of the elementary stream data;
a step that adds a movie playlist extension file for reproduction control of three-dimensional video stream data to the movie playlist file for reproduction control of the elementary stream data and registers playlist file information of the dependent view to that extension file;
a step that registers clip information file information of the base view to a clip information file for reproduction control of the elementary stream data; and
a step that adds a clip information extension file for reproduction control of three-dimensional video stream data to the clip information file for reproduction control of the elementary stream data and registers clip information file information of the dependent view to that extension file.

6. The computer-readable storage medium as set forth in claim 4, wherein
the first processing step includes a step that downloads the left-eye video image file and the right-eye video image file via an electrical communication line.

7. A conversion method to three-dimensional video images, comprising:
a first processing step that demultiplexes each of a base view stream file and a dependent view stream file which are to be used for a reproduction process of three-dimensional video images in accordance with SSIF method; and
a second processing step that multiplexes the demultiplexed data of the base view stream file and the dependent view stream file into one elementary stream data at least without encoding and in accordance with MPEG4-MVC standard, wherein
the second processing step multiplexes unprocessed image data as a dependent view of the elementary stream data without processing extraction of a difference between image data of the dependent view stream file and image data of the base view stream file.

8. A reproduction method for three-dimensional video images, comprising:
a first processing step that demultiplexer each of a base view stream file and a dependent view stream file which are to be used for a reproduction process of three-dimensional video images in accordance with SSIF method;
a second processing step that multiplexes the demultiplexed data of the base view stream file and the dependent view stream file into one elementary stream data at least without encoding and in accordance with MPEG4-MVC standard; and
a third processing step that performs reproduction process for the elementary stream data obtained in the second processing step, wherein
the second processing step multiplexes unprocessed image data as a dependent view of the elementary stream data without processing extraction of a difference between image data of the dependent view stream file and image data of the base view stream file.

9. The reproduction method for three-dimensional video images as set forth in claim 8, wherein
the third processing step transmits the elementary stream data obtained in the second processing step via an electrical communication line and performs a reproduction process using BD-LIVE.

10. The reproduction method for three-dimensional video images as set forth in claim 8, wherein
the third processing step records the elementary stream data obtained in the second processing step in a medium and performs a reproduction process from the medium.
